(19) United States
(12) Patent Application Publication
(10) Pub. No.: US 2017/0030070 A1
(43) Pub. Date: Feb. 2, 2017

(54) SHELTER AND ENTRY UNIT FOR A SHELTER

(71) Applicant: California Industrial Facilities Resources, Inc., dba: CAMSS Shelters, Kirkland, WA (US)

(72) Inventor: Douglas T HOTES, Kirkland, WA (US)

(21) Appl. No.: 15/224,582

(22) Filed: Jul. 31, 2016

Related U.S. Application Data
(60) Provisional application No. 62/199,097, filed on Jul. 30, 2015.

(51) Int. Cl. E04B 1/19; E04B 1/32; E04H 9/00; E06B 7/00; E06B 3/32; E06B 3/46; E06B 3/38; E06B 3/36; E05F 11/54; E05F 1/08; E05D 13/00; E06B 3/44; E04H 5/00; E06B 3/42

(52) U.S. Cl. CPC E04B 1/19; E04H 5/00; E04B 1/32; E04H 9/00; E06B 7/00; E06B 3/32; E06B 3/42; E06B 3/38; E06B 3/36; E05F 11/54; E05F 1/08; E05D 13/00; E06B 3/44; E06B 3/4636

(57) ABSTRACT

A shelter includes: a shelter framework including (a) first and second frames, and (b) a plurality of purlin members, each purlin member interposing between the first frame and the second frame; a cover positioned over the shelter framework; a doorcase, secured to and positioned within the first frame, having a central portion, a first side portion and a second side portion, the central portion having an upper section that includes tracks on each side; a center door, extending from a top of the central portion of the doorcase to a bottom of the central portion of the doorcase, having a sliding structure on each side edge; and a first and a second door, each extending from the top of the corresponding side portion of the doorcase to the bottom of the corresponding side portion of the doorcase, the side doors being positioned on opposing sides of the center door, each side door including a track on the side adjacent the center door. When the center door is closed, the sliding structure is positioned within the tracks of the upper portion of the doorcase and the tracks of the side door.

### CROSS-REFERENCE TO RELATED APPLICATIONS

This application claims the benefit of U.S. Provisional Application No. 62/199,097, filed Jul. 30, 2015, which is expressly incorporated herein in its entirety by reference thereto.

### BACKGROUND INFORMATION

Shelters, e.g., portable shelters, are commonly used by the U.S. military and others, and are occupiable for housing military or other personnel, equipment, and/or supplies, or for providing services such as cooking, dining, medical care, etc. Shelters are also used by organizations that provide humanitarian aid throughout the world. Such organizations commonly need to erect portable shelters in areas that have suffered from natural disasters, such as floods, tsunamis, hurricanes and the like. Ideally, these shelters should be designed for storage in a compact configuration that can be easily transported to a new destination for assembly and built for rugged use. Moreover, these shelters should be lightweight to make transportation easier and to make set up and disassembly manageable by a minimum number of people.

The portable shelters can be tall to accommodate a door assembly. In operation, when the door is raised it stacks above the doorframe. The added height increases the physical dimensions of the shelters which leads to costly shipping charges, particularly for air freight.

### SUMMARY

According to an example embodiment of the present invention, a shelter includes a shelter framework, having first and second frames, and a plurality of purlin members, each purlin member interposing between the first frame and the second frame. A cover is positioned over the shelter framework. A doorcase, secured to and positioned within the first frame, includes a central portion, a first side portion and a second side portion, the central portion having an upper section that includes tracks on each side. A center door, extending from a top of the central portion of the doorcase to a bottom of the central portion of the doorcase, includes a sliding structure on each side edge. A first and a second door are provided, each extending from the top of the corresponding side portion of the doorcase to the bottom of the corresponding side portion of the doorcase, the side doors being positioned on opposing sides of the center door, each side door including a track on the side adjacent the center door. When the center door is closed, the sliding structure is positioned within the tracks of the upper portion of the doorcase and the tracks of the side door.

The shelter may include an opening mechanism, attached to the center door.

The opening mechanism may include a pulley and/or spring assembly.

The shelter may include a side opening mechanism, attached to one of the side doors.

At least one of the side doors may be pivotable.

The center door may be arranged as a roll-up door or as a swing-up door.

The shelter may include an entry door positioned between one of the side portions of the doorcase and the shelter framework.

The side doors may have different dimensions.

The shelter may include an entry door positioned within at least one of the side doors.

According to an example embodiment of the present invention, an entry unit for a structure includes: a doorcase, secured to the structure, having a central portion, a first side portion, and a second side portion, the central portion having an upper section that includes tracks on each side; a center door, extending from a top of the central portion of the door frame to a bottom of the central portion of the doorcase, having a sliding structure on each side edge; and a first and a second door, each extending from the top of the corresponding side portion of the doorcase to the bottom of the corresponding side portion of the doorcase, wherein the side doors are positioned on opposing sides of the center door, each side door including a track on the side adjacent the center door. When the center door is closed, the sliding structure is positioned within the tracks of the upper portion of the doorcase and the tracks of the side door.

Further features and aspects of example embodiments of the present invention are described in more detail below with reference to the appended Figures.

### BRIEF DESCRIPTION OF THE DRAWINGS

FIG. 1 illustrates an embodiment of an entry unit for a shelter having a vertically opening center door interposing between two one-piece horizontally opening side doors.

FIG. 2 illustrates an embodiment of an entry unit for a shelter having a vertically opening center door interposing between two two-piece horizontally opening side doors.

FIG. 3A illustrates the embodiment of FIG. 2 showing both side doors in an open position.

FIG. 3B illustrates the embodiment of FIG. 2 showing both side doors in an open position and the center door partially raised.

FIG. 4 illustrates an embodiment of an entry unit for a shelter having a vertically opening center door interposing between two two-piece horizontally opening side doors.

FIG. 5A illustrates an embodiment where the vertical center door is shown partially retracted toward the roof of the shelter.

FIG. 5B shows a sliding structure of the center door positioned in a track.

FIG. 5C illustrates an embodiment where the vertical center door is shown fully retracted toward the roof of the shelter.

FIG. 6 illustrates an embodiment of an entry unit for a shelter having a vertically opening center door interposing between two two-piece horizontally opening side doors and having an entry door that interposes between one of the side doors and the shelter side wall.

FIG. 7 illustrates an embodiment of an entry unit for a shelter having a vertically opening center door interposing between a vertically retracting side door and a horizontally retracting side door.

### DETAILED DESCRIPTION

The entry unit shown in the accompanying drawings allows an entry opening comparable to the size of a shelter. One of the benefits of providing such a structure, with construction similar to that used for the shelter itself, is that the door can be assembled without the use of heavy or specialized equipment.

There are various ways to construct this entry opening, but assembly equipment considerations, as well as weight and ease of shipment, are important factors. The erection of the entry unit should be comparable in complexity, difficulty, and/or use of special equipment to that of the accompanying building. Likewise, the entry unit parts should be no heavier, or more difficult or expensive to ship, than the accompanying building itself Air shipment in particular can be problematic for such structures.

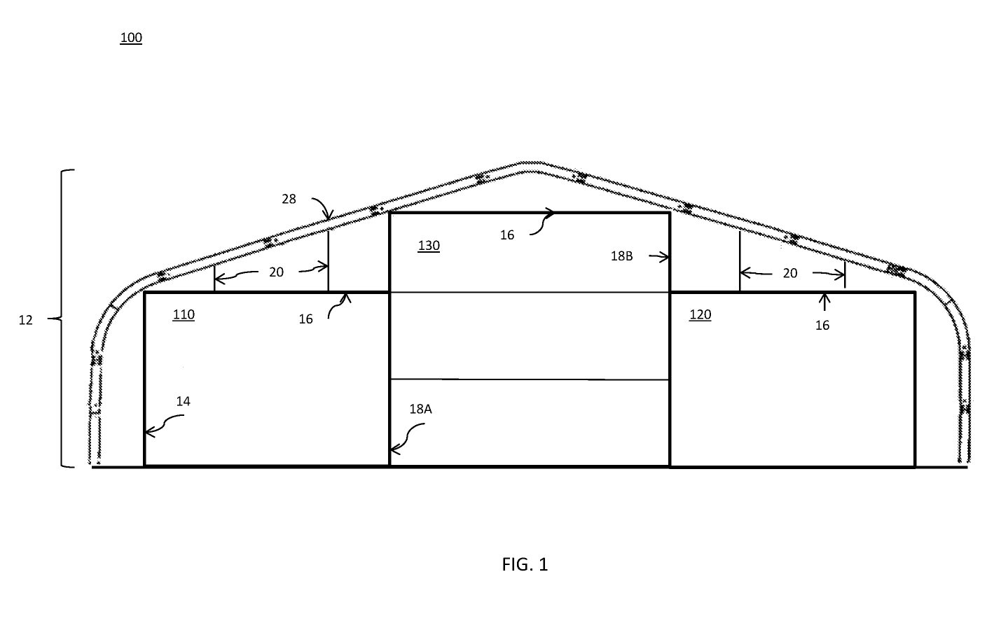

FIG. 1 illustrates a front view of an embodiment of an entry unit for a shelter 100 having a vertically opening center door 130 interposing between two one-piece horizontally opening side doors 110, 120.

The entry unit is positioned at one end of the shelter. The shelter includes a shelter framework and a cover. The shelter framework includes a purlin assembly, a first frame, e.g., a front frame, and a second frame, e.g., a back frame. The purlin assembly includes purlin members that connect the first frame and the second frame. The purlin members may extend from a joint between members 28 of the first frame to a similar joint between members 28 of the second frame. The cover is positioned over the shelter framework. Frame attachments secure the entry unit to the shelter.

The frame includes a plurality of members 28. The length of the members 28 may allow for space efficient storage and packing. Some members may be optionally curved to reduce potential damage to the cover. Optional middle frames having a similar structure the first frame and the second frame may be included to, e.g., provide for structural rigidity, extend the length of the shelter, etc.

The entry unit includes a doorcase 14, a center door 130, and two side doors 110, 120. The doorcase 14, substantially the width and height of the shelter, is positioned within the plane defined by front frame 12. The doorcase 14 includes rails 16A, 16B, 16C and stiles 18A, 18B, 18C, 18D. Upper vertical bracings 20 connect the rails 16A, 16C to the members 28. Rail 16B may be directly connected to the members 28 or may be connected to the members 28 by bracings 20.

The doorcase 14 has a central portion, a first side portion, and a second side portion. The central portion has an upper section and a lower section. The lower section has a similar height to that of the first and second side portions. The stiles 18B, 18C of the upper section include tracks, as described in more detail below. The center door 130 extends from a top of the central portion of the doorcase 14 to a bottom of the central portion of the doorcase 14, e.g., to the ground. Each of the first and the second horizontally opening side doors 110, 120 extend from the top of the corresponding side portion of the doorcase 14 to the bottom of the corresponding side portion of the doorcase 14, e.g., to the ground.

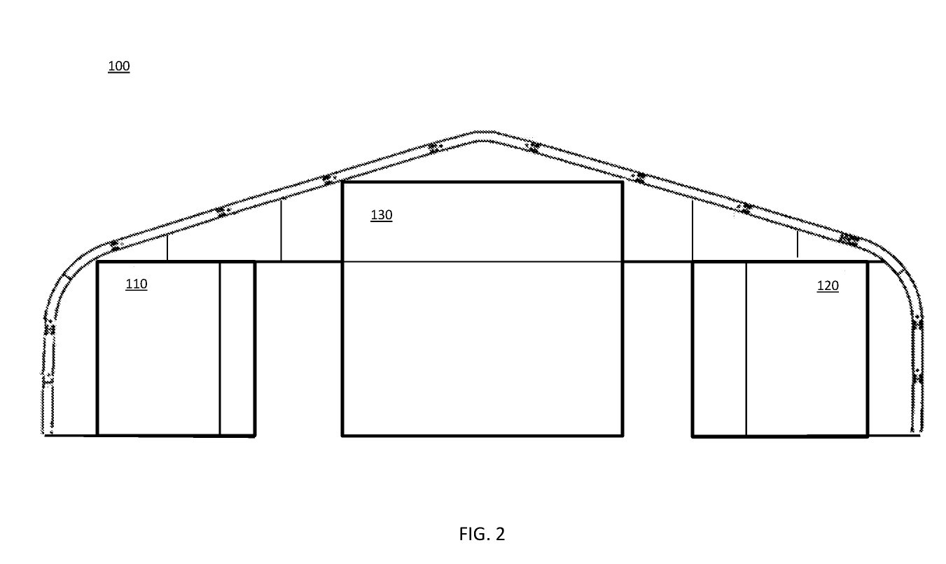

FIG. 2 illustrates an embodiment of the entry unit for a shelter 100 having a vertically opening center door 130 interposing between two two-piece horizontally opening side doors 110, 120. The side doors 110, 120 are in two pieces that can slide toward each other to create an opening on either side of center door 130, or can slide away from each other so that each door contacts center door 130.

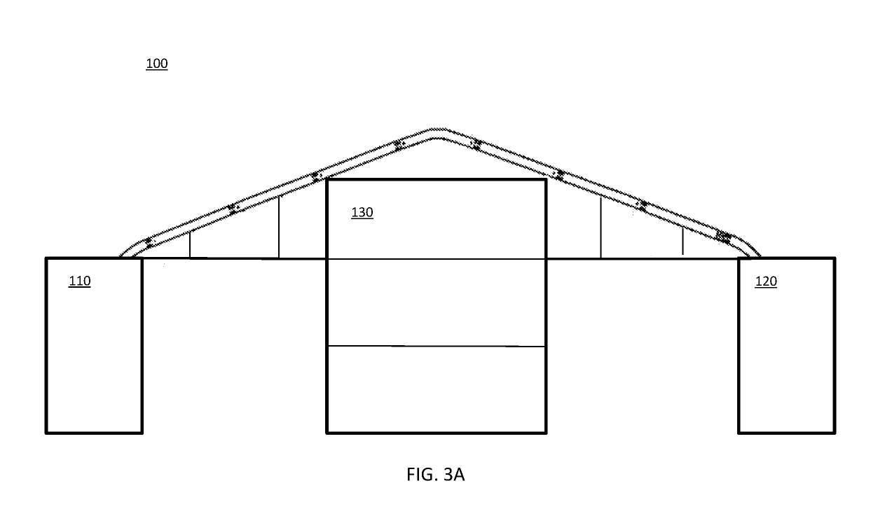

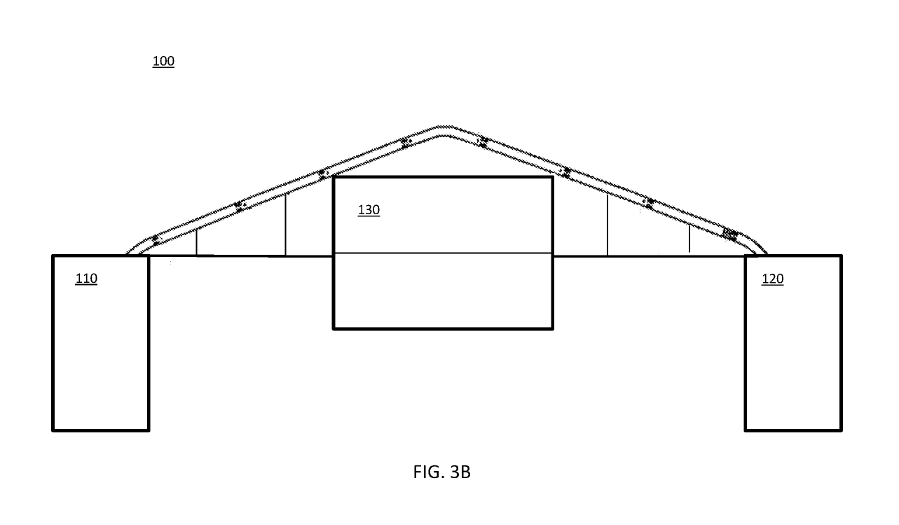

FIG. 3A illustrates the embodiment of FIG. 2 showing both side doors 110, 120 in an open position. The side doors 110, 120 may pivot away from door 130, so as to swing out to provide openings that are the same size as the doorcase 14. FIG. 3B illustrates the embodiment of FIG. 3A showing the center door 130 in the raised position.

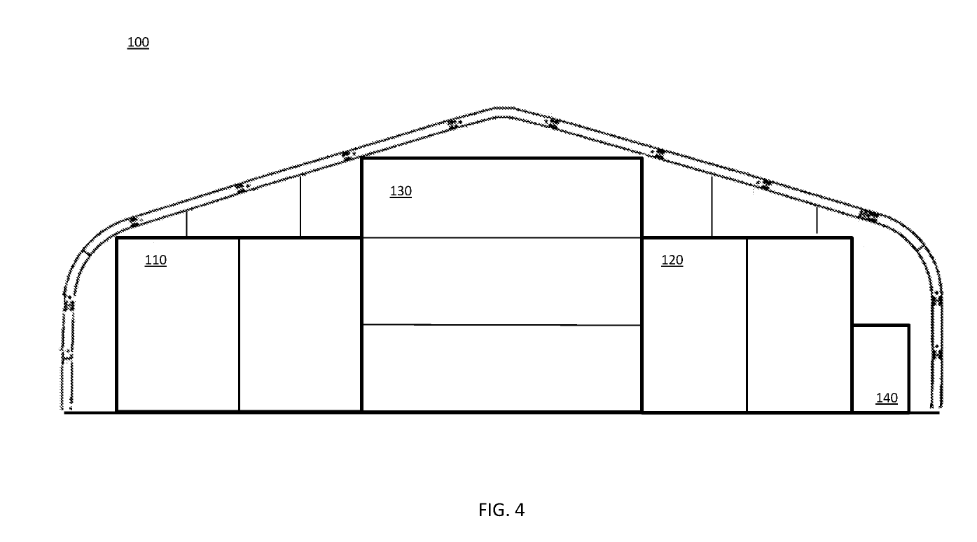

FIG. 4 illustrates an embodiment of the entry unit for a shelter 100 having a vertically opening center door 130 interposing between two two-piece horizontally opening side doors 110, 120. An entry door 140 is positioned on the pivotable edge of side door 120.

The side doors, as illustrated by side door 110, can be more than two pieces or, as illustrated by side door 120 can be one piece, as desired. Common to these embodiments is the ability to pivot the doors at one end way from the vertical center door 130 to allow ingress and egress.

The entry door 140 is sized to, for example, allow people to enter and exit. In that event, either side door 110, or side door 120, or both will be correspondingly narrower, and the smaller door(s) will be between the pivot(s) of side doors 110, 120, and the side walls of the shelter 100.

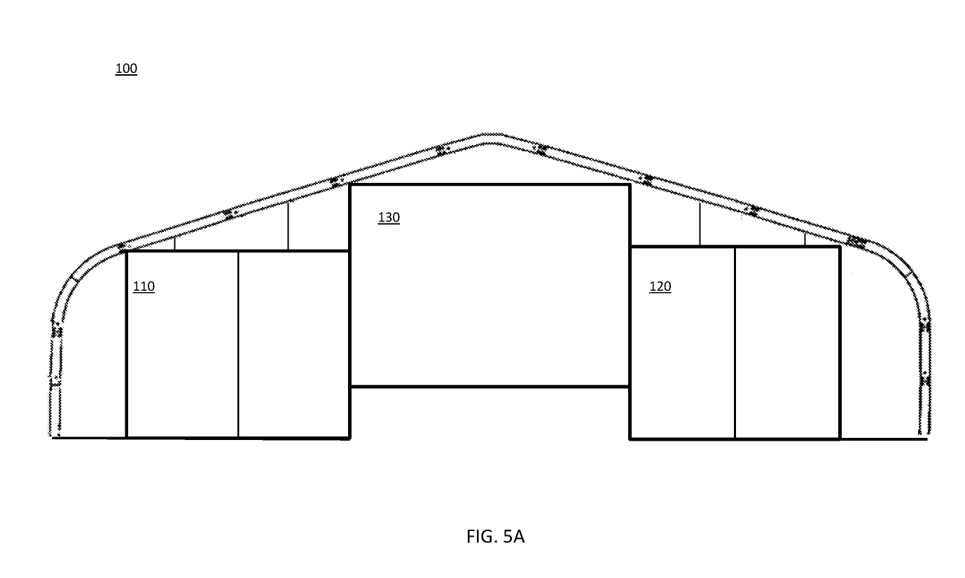

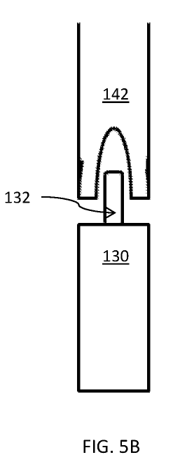

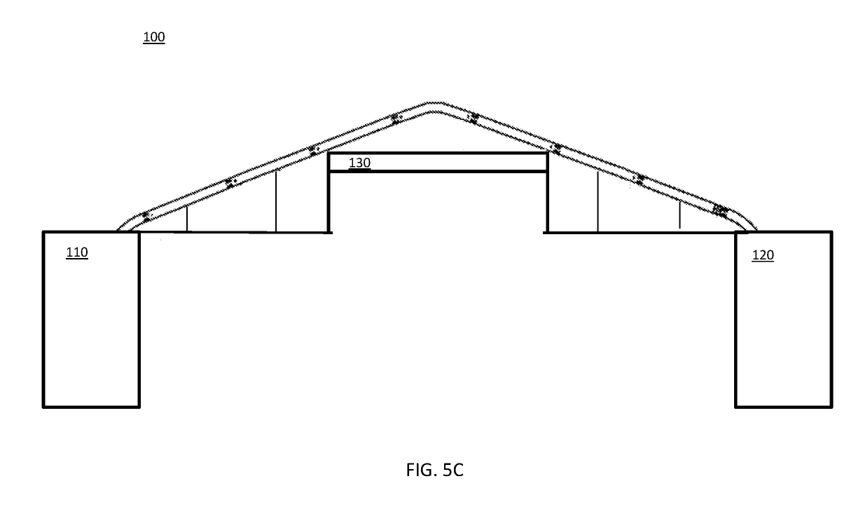

As shown in FIG. 5A, the vertical center door 130 is configured to retract upwardly toward the roof of shelter 100, in a manner similar that of a garage door that moves up and down on tracks. The center door 130 may be arranged as, e.g., a roll-up door, a swing-up door, etc. In order to facilitate that retraction, as shown in FIG. 5B, the sliding structure 132 of center door 130 is positioned within the parallel tracks 142. Each parallel track 142 may include two parts. A first part is provided in the stiles 18B, 18C, which extend from the top of the side doors 110, 120 to the central rail 16B. A second part is provided along a side edge of a corresponding side door 110, 120, and meets a respective first part so as to provide a sufficiently continuous track. Consequently, a pair of substantially continuous tracks 142 are provided for the door 130 to travel along.

When the vertical center door 130 opens, it moves upwardly along the tracks 142. When fully retracted, as shown in FIG. 5C, center door 130 is seated towards the top of the upper portion of the entry unit, parallel to the ground, and near the roof of shelter 100. The distance between the retracted door 130 and the roof depends on, e.g., the slope of the roof and the width of the center door 130. When the vertical center door 130 closes, it moves downwardly along the tracks 142 between side doors 110 and 120, until the bottom of door 130 reaches the ground.

In this embodiment, the side doors 110, 120 do not extend fully across the width of the shelter 100. The vertical center door 130 extends between the two doors 110, 120 so that the three doors 110, 120, 130 cooperate to close off the end of shelter 100.

Ball bearings, wheels, or other gliding/sliding/travelling structures 132 on either side of vertical door 130 engage tracks 142. Because the side doors 110, 120, and the track structure 142 integrated with the side doors 110, 120 are movable, a portion of the track structure moves when doors 110, 120 open and close. It is desirable that, every time that doors 110, 120 fully close after opening, the tracks along the edges of the doors are in as close to their original positions as possible. Various considerations, such as ground shifting, ground expansion, ground contraction, or various kinds of encumbrances, etc., can make this return to original position difficult, or at least inconsistently available. Nevertheless, when the doors 110, 120 are closed, the tracks 142 along the edges of those doors 110, 120 need to be positioned so that the vertical door 130 can engage them. Moreover, the tracks on the edges of the doors 110, 120 need to align with tracks which may be above those doors, so that the vertical center door 130 can move continuously between a retracted (open) and a closed position.

To address the need for track alignment, a guide may be provided either at the top of the tracks 142 in the doors 110, 120 or at the bottom of the tracks 142 in the stiles 18B, 18C, so that, as the vertical center door 130 travels, it is guided into the tracks 142 at the juncture between the doors 110, 120 and the stiles 18B, 18C. This guide structure can have various shapes, any of which may facilitate movement of door 130 continuously along tracks 142 when opening and closing. The guide's geometry may also depend, for example, on whether the guide is provided in the doors 110 120 or in the stiles 18B, 18C.

Each side door 110, 120, when opened, provides an opening to accommodate, e.g., the moving of forklifts, trucks, and other vehicles in and out of shelter 100 without having to open a large overall horizontal door assembly, and in some cases without have to raise the vertical center door 130 as well. The height of the side doors 110, 120 may be selected to accommodate vehicles of various heights.

For tall vehicles (or high forklift loads), the vertical center door 130 can be opened, independently of side doors 110, 120, e.g., allowing side doors 110, 120 to remain closed. Depending on the width of vehicles to be accommodated, it may be desirable to select the width of vertical center door 130 to accommodate such vehicles, so that only the vertical center door 130 needs be opened. The ability to selectively open fewer than all of the three doors 110, 120, and 130 to accommodate ingress and egress makes the door assembly versatile.

When all three doors 110, 120, 130 are open, an airplane's wings and tail structure can be accommodated. The side doors 110, 120 may be tall enough to accommodate a main rotor of a helicopter.

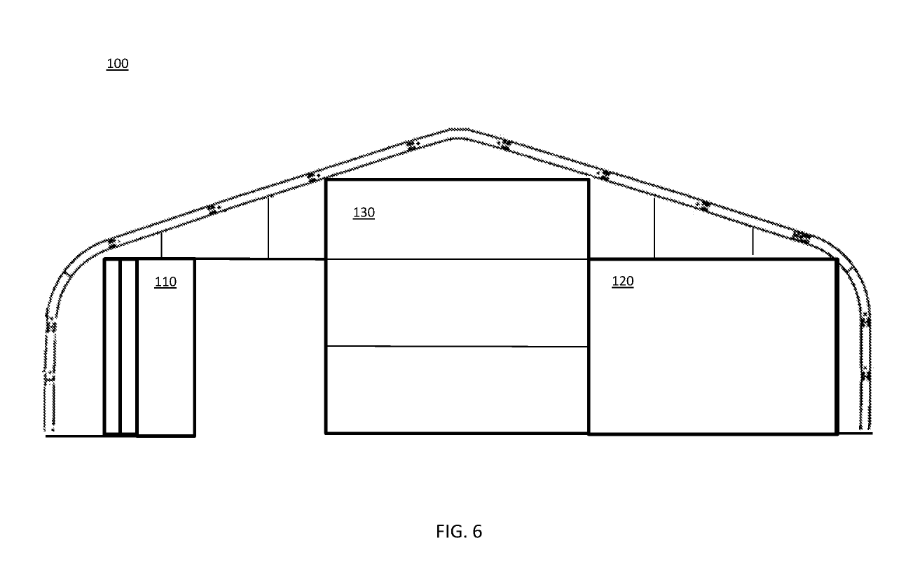

FIG. 6 illustrates an embodiment of an entry unit for a shelter 100, having a vertically opening center door 130 interposing between two two-piece horizontally opening side doors 110, 120. The side doors 110, 120 are of unequal dimensions. An entry door 140 is positioned at the pivotable edge of side door 120 and the shelter wall. The side doors 110, 120, are smaller than the center door 130, and the side doors 110, 120 may have different heights and widths.

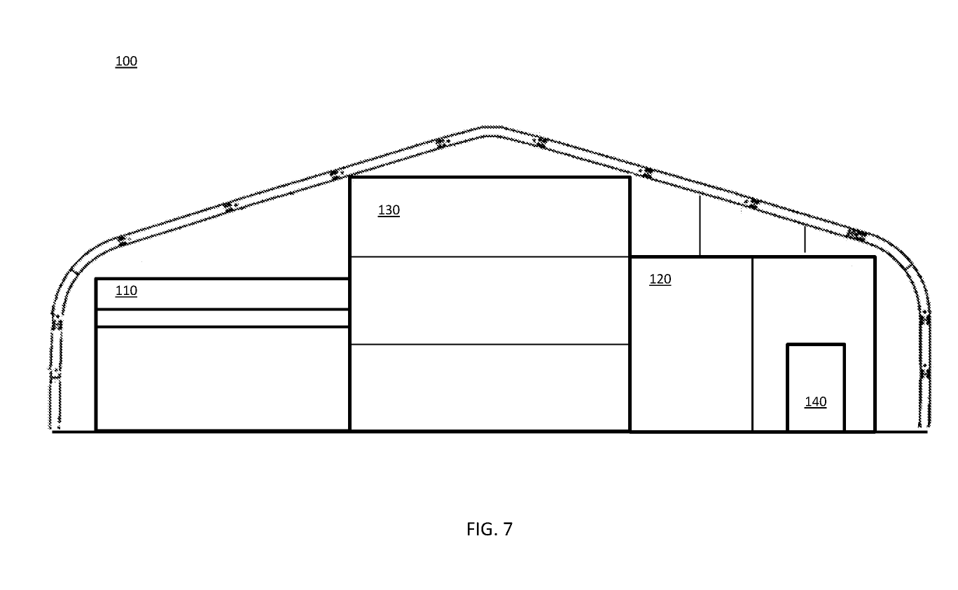

FIG. 7 illustrates an embodiment of an entry unit for a shelter 100 having a vertically opening center door 130 interposing between a vertically retracting side door 110 and a horizontally retracting side door 120. The side doors 110, 120 are of unequal dimensions. An entry door 140 is positioned within a portion of the horizontally retracting side door 120.

The side door 110 retracts vertically. The side door 120 retracts horizontally and is pivotable along the shelter side. An entry door 140 may be latched into the side door 120 when the side door 120 is retracted.

A pulley system and/or spring system may be provided to facilitate opening and closing of the center door 130.

What is claimed is:

1. A shelter comprising:
a shelter framework including:
first and second frames, and
a plurality of purlin members, each purlin member interposing between the first frame and the second frame;
a cover positioned over the shelter framework;
a doorcase, secured to and positioned within the first frame, having a central portion, a first side portion and a second side portion, the central portion having an upper section that includes tracks on each side;
a center door, extending from a top of the central portion of the doorcase to a bottom of the central portion of the doorcase, having a sliding structure on each side edge; and
a first and a second door, each extending from the top of the corresponding side portion of the doorcase to the bottom of the corresponding side portion of the doorcase, the side doors being positioned on opposing sides of the center door, each side door including a track on the side adjacent the center door;
wherein when the center door is closed, the sliding structure is positioned within the tracks of the upper portion of the doorcase and the tracks of the side door.

2. A shelter, as in claim 1, further including an opening mechanism, attached to the center door.

3. A shelter, as in claim 2, wherein the opening mechanism includes a pulley and/or spring assembly.

4. A shelter, as in claim 1, further including a side opening mechanism, attached to one of the side doors.

5. A shelter, as in claim 1, wherein at least one of the side doors is pivotable.

6. A shelter, as in claim 1, wherein the center door is arranged as a roll-up door or as a swing-up door.

7. A shelter, as in claim 1, further including an entry door positioned between one of the side portions of the doorcase and the shelter framework.

8. A shelter, as in claim 1, wherein the side doors have different dimensions.

9. A shelter, as in claim 2, further including an entry door positioned within at least one of the side doors.

10. An entry unit for a structure comprising:
a doorcase, secured to the structure, having a central portion, a first side portion, and a second side portion, the central portion having an upper section that includes tracks on each side;
a center door, extending from a top of the central portion of the door frame to a bottom of the central portion of the doorcase, having a sliding structure on each side edge; and
a first and a second door, each extending from the top of the corresponding side portion of the doorcase to the bottom of the corresponding side portion of the doorcase, wherein the side doors are positioned on opposing sides of the center door, each side door including a track on the side adjacent the center door;
wherein when the center door is closed, the sliding structure is positioned within the tracks of the upper portion of the doorcase and the tracks of the side door.

11. An entry unit, as in claim 10, further including an opening mechanism, attached to the center door.

12. An entry unit, as in claim 11, wherein the opening mechanism includes a pulley and/or spring assembly.

13. An entry unit, as in claim 10, further including a side opening mechanism, attached to one of the side doors.

14. An entry unit, as in claim 10, wherein one of the side doors is pivotable to expose the opening defined by corresponding side portion of the doorcase.

15. An entry unit, as in claim 10, wherein the center door is arranged as a roll-up door or as a swing-up door.

16. An entry unit, as in claim 10, further including an entry door positioned between one of the side portions of the doorcase and the structure.

17. An entry unit, as in claim 10, wherein the two side doors have different dimensions.

18. An entry unit, as in claim 10, further including an entry door positioned within at least one of the side doors.
